(19) United States
(12) Patent Application Publication
(10) Pub. No.: US 2008/0104516 A1
(43) Pub. Date: May 1, 2008

(54) SYSTEM AND METHOD FOR EDITING SLIDESHOW

(75) Inventor: Ying-Chun Lee, Pingtung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ULEAD SYSTEMS, INC., Taipei (TW)

(21) Appl. No.: 11/616,889

(22) Filed: Dec. 28, 2006

(30) Foreign Application Priority Data
Oct. 25, 2006 (TW) 95139353
Nov. 29, 2006 (CN) 200610163946.5

(51) Int. Cl. G06F 3/00

(52) U.S. Cl. 715/732; 715/730

(57) ABSTRACT

A slideshow editing system for editing images into slideshow comprises an input device for sending a control signal to a host. The host receives the control signal and executes application programs to preview and edit image files with real time feedback, and interactively edit the slideshow and display the slideshow on a display device. Thus, the user may gain the advantage of not editing images and slideshows on the video timeline.

### CROSS-REFERENCE TO RELATED APPLICATION

This application claims the priority benefits of Taiwan application serial no. 95139353, filed Oct. 25, 2006 and of P.R.C. application serial no. 200610163946.5, filed Nov. 29, 2006. All disclosures of the Taiwan application and the P.R.C. application are incorporated herein by reference.

### BACKGROUND OF THE INVENTION

1. Field of the Invention

The present invention generally relates to a system and a method for editing a slideshow, and more particularly, to a system and a method for editing a slideshow using a simple input device.

2. Description of Related Art

Along with the rise of home digital electronic appliances, more and more application programs are developed to provide a variety of user interfaces for allowing a user to remotely manipulate a TV set coupled to and controlled by a computer host. However, most of the application programs are designed for being manipulated by a computer keyboard or a mouse, and therefore it is hard to manipulate the application programs using, for example, a TV remote controller.

In particular, for previewing and editing a digital image into a slideshow using an application program, several mouse dragging steps and timeline schedule operations are required, which cause great inconvenience to the user. Furthermore, the operations of the application programs may not be easily implemented by simple key-based device.

Accordingly, the present invention provides a slideshow editing system and method thereof capable of allowing a user to remotely and interactively preview, adjust/correct and edit image files into a slideshow on a real-time basis by using a simple input device.

### SUMMARY OF THE INVENTION

The present invention is directed to a slideshow edit system capable of allowing a user to control a host to easily navigate an application program using a simple input device to allow the user to preview image files on a real-time basis and interactively edit one or more image files and adjust a slideshow. Thus, the steps of editing, adjusting and displaying slideshow on the video timeline may be effectively avoided.

The present invention is also directed to a slideshow editing method for allowing a user to manipulate a plurality of slideshow edit user interfaces for interactively editing one or more image files into a slideshow and adjusting the slideshow using a simple input device. Thus, the steps of editing and adjusting on the video timeline may be effectively avoided.

The present invention provides a slideshow editing system including an input device, a host and a display device. The input device sends out a control signal when the user presses four-direction keys and a confirmation key of the input device. The host receives the control signal and executes commands to control the application program to preview and edit an image file with real time feedback, and interactively edit and adjust a slideshow without editing and adjusting and displaying slideshow on the video timeline. The edited and adjusted image files and slideshow are displayed on the display device.

The present invention also provides a slideshow editing method, which includes the following steps. First, one or more image files are imported into a host. Then, the four-direction keys and a confirmation key of the input device may be manipulated (pressed) for sending a control signal to the host to navigate, preview and edit the image files. After that, a slideshow profile is generated by the program. Next, the slide show is previewed and edited by using the input device. Thus, the users need not to edit and adjust the video timeline directly. Finally, the slideshow is converted and then displayed on a display device.

In the present invention, a simple input device is used to control the host to control a program to preview and edit the image files and the slideshow via user interfaces without editing and adjusting the slideshow on the video timeline.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architecture block diagram of a slideshow editing system according to a preferred embodiment of the present invention.

FIG. 2 is a flowchart of a slideshow editing method according to the preferred embodiment of the present invention.

FIG. 3 is a user interface for previewing and editing image files according to an embodiment of the present invention.

FIG. 4 is a user interface for manually adjusting the image according to an embodiment of the present invention.

FIG. 5 is a user interface for previewing and editing a slideshow according to an embodiment of the present invention.

FIG. 6 is a user interface for editing slides according to an embodiment of the present invention.

FIG. 7 is a user interface for changing display duration according to an embodiment of the present invention.

FIG. 8 is a user interface for adding a caption according to an embodiment of the present invention.

FIG. 9 is a user interface for changing background templates according to an embodiment of the present invention.

FIG. 10 is a user interface for changing scene transition effect according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to an embodiment of the present invention, it is assumed that a user uses a simple input device, for example, a remote controller for previewing and editing image files, and for previewing and editing a slideshow.

However, one skilled in the art would understand that for the simple input device, for example, a remote controller, complicated pointing functions are not required. In fact, the keys of the simple input device are pressed to send control signals to control the host to navigate the program to edit the slideshow. For example, when the embodiment is applied in a portable multimedia device such as a cell phone, a personal digital assistant (PDA) or a kiosk machine, the simple input device serves as the keyboard of the devices.

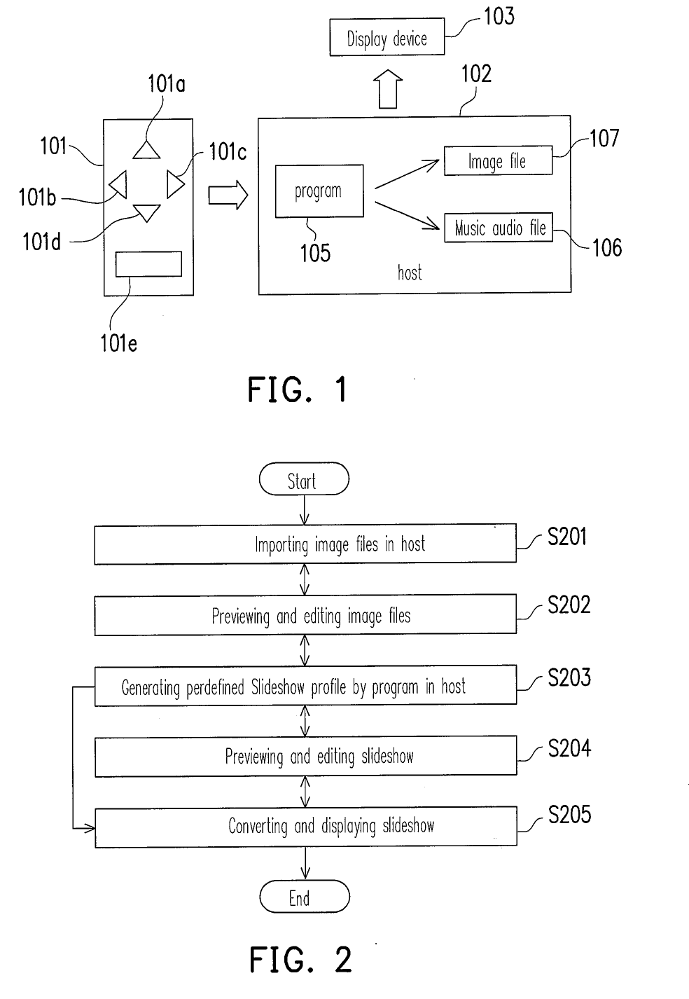

FIG. 1 is an architecture block diagram of the slideshow editing system according to a preferred embodiment of the present invention. Referring to FIG. 1, the user manipulates an input device 101, for example a remote controller, to send control signals to a host 102 to control an application program 105 for navigating and editing image files 107. The host 102 executes the program 105 and accesses a multimedia library including at least a music audio file 106 and the image file 107, so that the user may preview and edit the image files 107 with real time feedback and to interactively edit and adjust the slideshow. A display device 103 displays the resulting slideshow.

In an embodiment of the present invention, the user navigates the application 105 in the host 102 by pressing the keys of the simple input device 101. Compared to the keyboard of a general computer system, the input device 101 comprises less number of keys. Basically, the input device 101 comprises a set of four-direction keys 101a-101d and a confirmation key 101e suitable for navigation and execution by user; however, the input device 101 may not precisely move the cursor to a target point as in with a case of the mouse of a personal computer.

FIG. 2 is a flowchart of a slideshow editing method according to a preferred embodiment of the present invention. Referring to FIG. 2, first, the user imports one or more image files into a host (step S201). Second, the user presses a set of four-direction keys and a confirmation key on the input device for sending control signals to the host. Then, the host receives the signals and executes commands, for example, to preview and edit the image file (step S202). After that, the slideshow including the image files will be generated with a predefined profile (step S203). Next, the user previews and edits the slideshow by using the program in the host (step S204). Finally, the slideshow is converted and then displayed on a display device (step S205).

The user interfaces of the editing system according to an embodiment of the present invention allow the user to select various operations by controlling the input device, for example a desired function by controlling the four-direction keys of the input device, and then press confirmation key to execute the selected function.

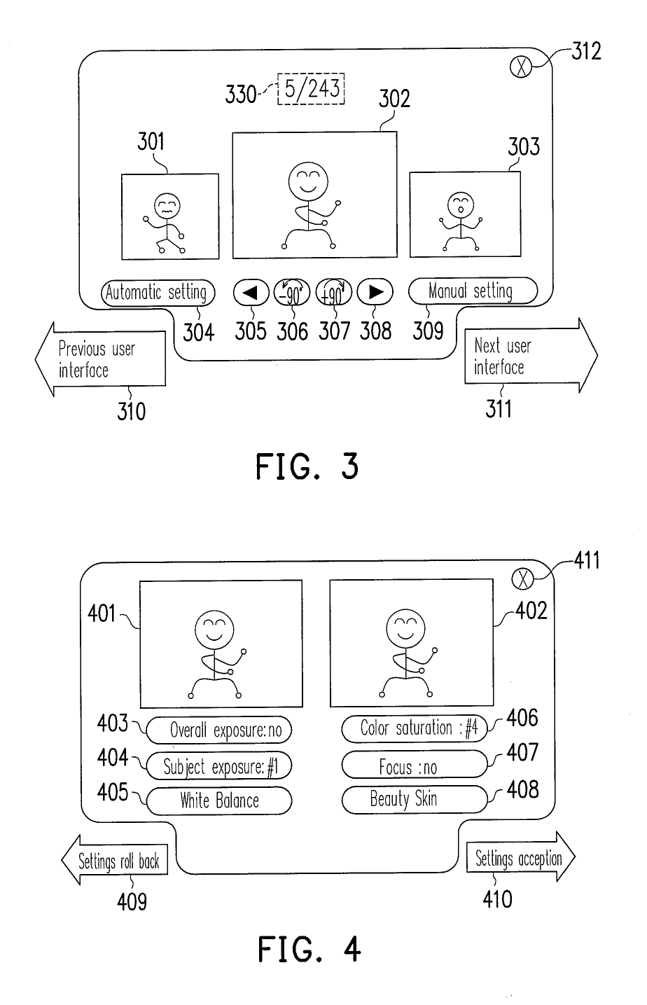

FIG. 3 shows a view of a user interface for previewing and editing images according to an embodiment of the present invention. Referring to FIG. 3, the user interface includes windows 301-303, a text box 330 and buttons 304-312. The window 302 displays the currently previewed image, the window 301 displays the previously previewed image and the window 303 displays the next image to be previewed. The text box 330 indicates the number of the currently previewed images on the window 302. For example, “5/243” means the fifth of the total 243 images is currently being previewed on the window 302.

When the user presses the input device to select and confirm the button 305, the window 302 displays the previously previewed image. When the user presses the input device to select and confirm the button 308, the window 302 displays the next image.

Thus, the user interface allows the user to preview and edit the image files. For example, when the user selects and presses the button 306, the image displayed on the window 302 rotates clockwise by 90°. When the user selects and presses the button 307, the image displayed on the window 302 rotates counter-clockwise by 90°. When the user selects and presses the button 304, the application 105 automatically adjusts the image displayed on the window 302. When the user selects and presses the button 309, the user is allowed to manually adjust the options for displaying the image on the window 302. The user interface for manually adjusting the options for displaying the image displayed on the window is shown in FIG. 4.

When the user selects and presses the button 310, the procedure returns to the step of importing images into the host (step S201). When the user selects and presses the button 311, a message indicating completion of the operation of previewing and editing the image is displayed (step S202), and the host creates a predefined slideshow profile (step S203). At this time, if the user selects and presses the button 312, the editing operation is ended (i.e. the slideshow editing system is turned off).

Referring to FIG. 4, the user interface for manually adjusting the options includes windows 401 and 402 and buttons 403-411. The window 401 is for displaying the currently previewed image before manual adjustment and the window 402 is for displaying the currently previewed image after manual adjustment.

When the user selects and presses the button 403, the user is allowed to adjust the overall exposure of the currently previewed image. When the user selects and presses the button 404, the user is allowed to adjust a local exposure of the currently previewed image, for example, a specific area in the image (such as, a figure). When the user selects and presses the button 405, the user is allowed to adjust the white balance of the currently previewed image. When the user selects and presses the button 406, the user is allowed to adjust the colour saturation on the currently previewed image. When the user selects and presses the button 407, the user is allowed to adjust the focus on the currently previewed image. When the user selects and presses the button 408, the user is allowed to adjust a special colour (for example, the skin colour) in an area.

When using the user interface for manually adjusting the options, a plurality of default values provided by the slide editing system may be used. For example, when the user presses the button 403 for the first time, the overall exposure is changed from ‘nothing’ to ‘#1’; when the user presses the button 403 once again, the overall exposure is changed from ‘#1’ to ‘#2’, and so on. In addition, when the user selects and presses the button 409, the previous editing command is rolled back and the system returns to the user interface of previewing and editing images (i.e. FIG. 3). When the user selects and presses the button 410, the options manually adjusted by the user would be saved and the system returns to the user interface of previewing and editing images (i.e. FIG. 3). When the user selects and presses the button 411, the editing step will be completed (the slideshow editing system is turned off).

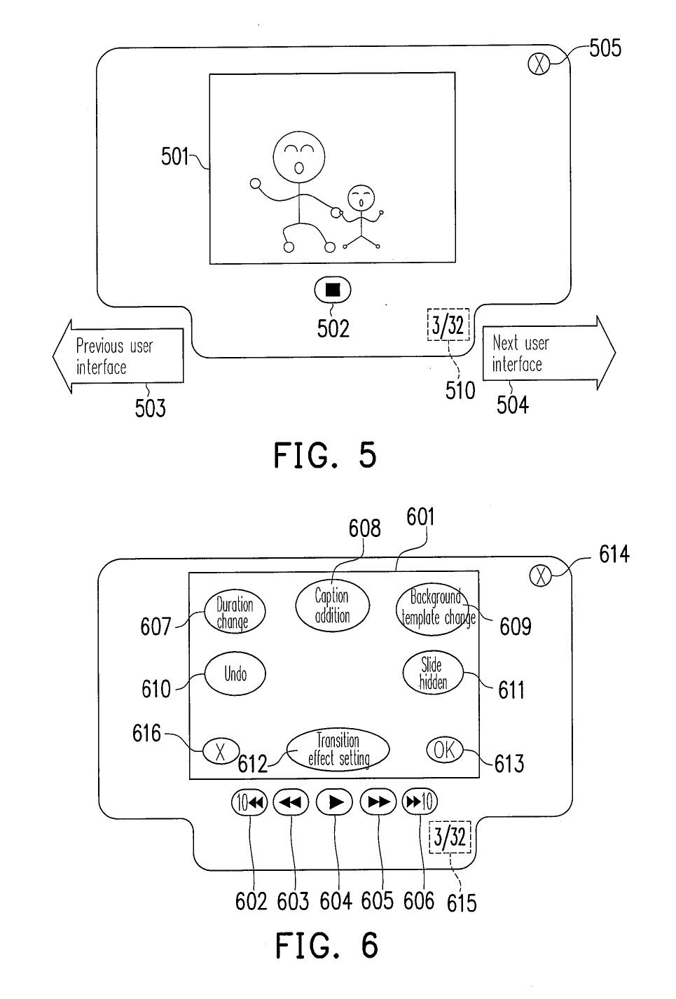

Once the above operation of previewing and editing images (step S202) is completed, the host creates a predefined slideshow profile (step S203). FIG. 5 is a user interface for previewing and editing a slideshow according to the embodiment of the present invention. Referring to FIG. 5, the user interface includes a window 501, a text box 510 and buttons 503-505. The window 501 displays the currently previewed slide and the preview is comprised of a real-time slideshow rendering system. In default setting, the display duration for each slide is the same. The text box 510 indicates the number of the currently previewed slides on the window 501, for example, “3/32” means the third slide of the total 32 slides is currently being previewed on the window 501.

The user edits the slideshow using the user interface. When the user selects and presses the button 502, the slideshow is stopped playing and allows the user to modify the slideshow options, i.e., previewing and editing slideshow concurrently are executed (S204). When the user selects and presses the button 503, the system returns to the image editing page (Step S202 and the user interface of FIG. 3). When the user selects and presses the button 504, the slideshow editing is completed and generation of the slideshow is initiated. When the user selects and presses the button 505, the editing process of the slideshow is cancelled (the application will be closed).

If the user wants to change the effects and profile of the slideshow, the user may select and press the button 502 for changing the options (step S204).

FIG. 6 is a user interface for previewing and editing slideshow according to the embodiment of the present invention. Referring to FIG. 6, the user interface includes a window 601, a text box 615 and buttons 602-614. The window 601 displays the slide that is currently being edited. The text box 615 indicates the number of the currently edited slides, for example, “3/32” means the third slide of the total 32 slides is being currently edited.

The user selects and presses the button 602 to jump 10 slides backward. For example, if the user currently previews the thirteenth slide of the total 32 slides, after the button 602 is pressed, the third slide of the total 32 slides will be displayed on the window 601. The user selects and presses the button 603 to preview the previous slide. The user selects and presses the button 605 to preview the next slide. The user selects and presses the button 606 to jump 10 slides forward. For example, if the user currently previews the third slide in the total 32 slides, after the button 606 is pressed, the thirteenth slide of the total 32 slides is displayed on the window 601. When the user selects and presses the button 604, the window 601 of the user interface displays the slides.

By using the user interface shown in FIG. 6, the slideshow could be customized for his/her style. When the user selects and presses the button 607, the system is able to change the display duration time of the currently shown slide. When the user selects and presses the button 608, a caption is added into the currently shown slide. When the user selects and presses the button 609, the background template is changed. When the user selects and presses the button 610, the previous command is recovered and the system returns to the user interface shown in FIG. 5. When the user selects and presses the button 611, the current slide is removed or hidden from the slideshow. When the user selects and presses the button 612, the user is allowed to select a transition effect for the current slide. When the user selects and presses the button 613, all the changes will be applied to the slideshow profile and the system returns to the user interface shown FIG. 5. When the user selects and presses the button 614, the editing is cancelled (the application will be closed). When the user selects and presses the button 616, all the changes will not be applied and the system returns back to the user interface shown FIG. 5.

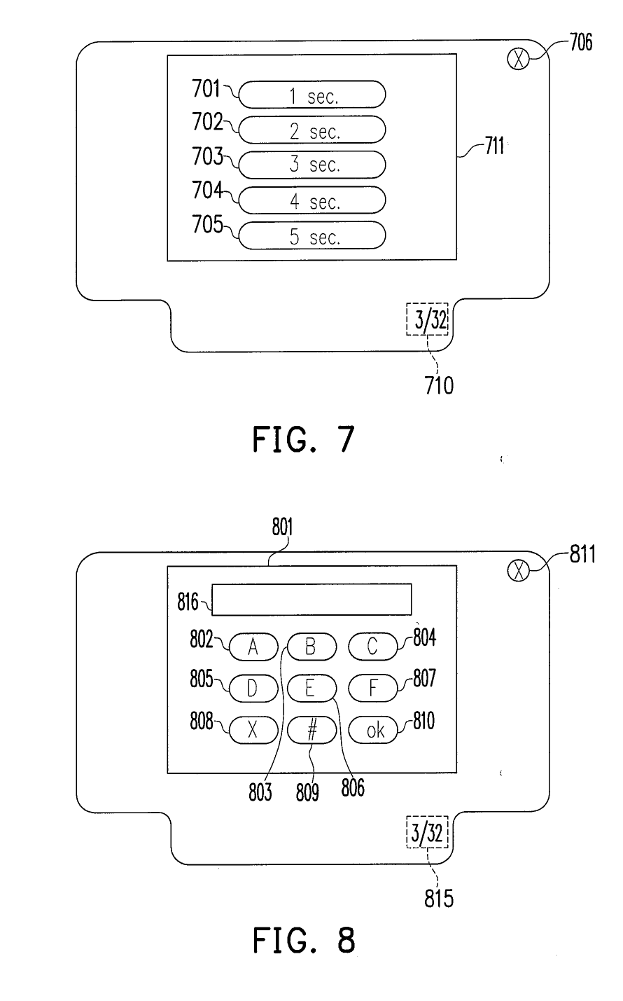

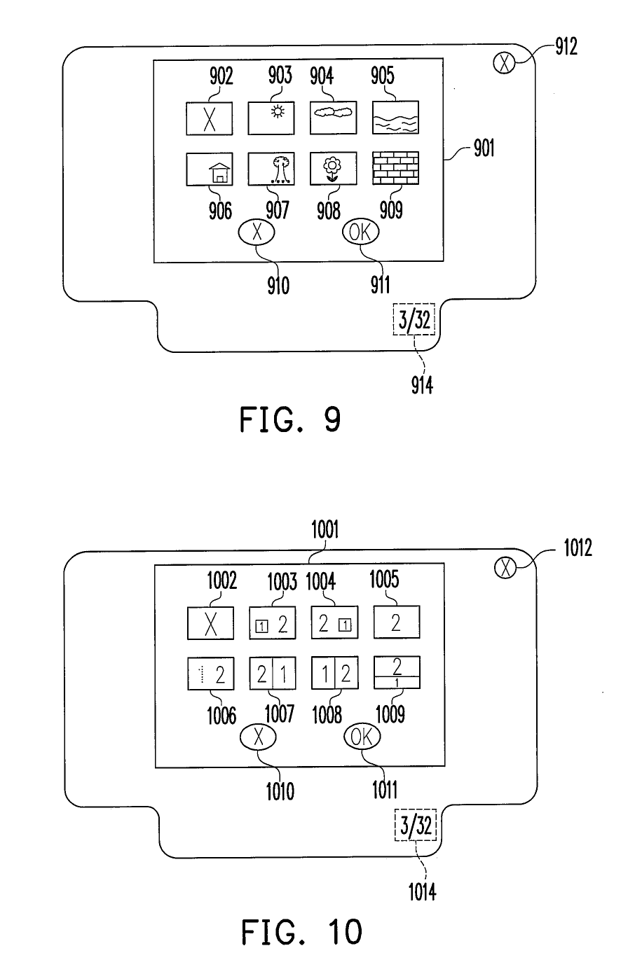

In addition, when the user selects and presses the button 607, the button 608, the button 609 or the button 612, the system would respectively go to the user interface for changing the display duration time (as shown in FIG. 7), the user interface for adding a caption (as shown by FIG. 8), the user interface for changing a background template (as shown by FIG. 9) or the user interface for changing a scene transition effect (as shown in FIG. 10). All the options have a plurality of default values provided by the slideshow editing system and available for the user to choose.

FIG. 7 is a diagram of the user interface for changing the display duration time according to the embodiment of the present invention. Referring to FIG. 7, the user interface includes a window 711, buttons 701-706 and a text box 710. The window 711 displays the currently previewed slide. The text box 710 indicates the number of the currently edited slides, for example, “3/32” means the third slide of the total 32 slides is currently being edited. When the user selects and presses one of the buttons 701-705, the slide duration time could be selected between 1 second to 5 seconds (for example, a default value may be 3 seconds). When the user selects and presses one of the buttons 701-705, the system returns to the user interface of FIG. 5. When the user selects and presses the button 706, the editing is cancelled (the application will be closed).

FIG. 8 is a diagram of the user interface for adding caption according to the embodiment of the present invention. Referring to FIG. 8, the user interface includes a window 801, text boxes 815 and 816 and buttons 802-811. The window 801 displays the currently previewed slide. The text box 815 indicates the number of the currently edited slides, for example, 3/32 means the third slide of the total 32 slides is currently being edited. The text box 816 displays the newly added caption text. When the user selects and presses one of the buttons 802-807, or the button 809, or a combination thereof, a text may be entered. When the user selects and presses the button 808, the newly entered text would be deleted and the system returns to the user interface shown in FIG. 5. When the user selects and presses the button 810, the system accepts the newly entered text and returns to the user interface shown in FIG. 5. When the user selects and presses the button 811, the editing is cancelled (the application will be closed).

FIG. 9 is a diagram of the user interface for changing background templates according to the embodiment of the present invention. Referring to FIG. 9, the user interface includes a window 901, a text box 914 and buttons 902-912. The window 901 displays the currently previewed slide. The text box 914 indicates the number of the currently edited slides, for example, “3/32” means the third slide of the total 32 slides is currently being edited. When the user selects and presses the button 902, the background template will be removed. When the user selects and presses one of the buttons 903-909, a special background template is added on the current slide. When the user selects and presses the button 910, the chosen background template is cancelled and the system returns to the user interface shown in FIG. 5. When the user selects and presses the button 911, the system would accept the newly chosen background template and the system returns to the user interface shown in FIG. 5. When the user selects and presses the button 912, the editing is cancelled (the application will be closed).

FIG. 10 is a diagram of the user interface for changing scene transition effect according to the embodiment of the present invention. Referring to FIG. 10, the user interface includes a window 1001, a text box 1014 and buttons 1002-1012. The window 1001 displays the currently previewed slide. The text box 1014 indicates the number of the currently edited slide, for example, 3/32 means the third slide in the total 32 slides is presently being edited. When the user selects and presses the button 1002, the scene transition effect will be removed. When the user selects and presses one of the buttons 1003-1009, the selected scene transition effect is applied between the current slide and the next slide. For example, the button 1003 stands for the transition effect of fading-out from left to right. When the user selects and presses the button 1010, the chosen scene transition effect is cancelled and the system returns to the user interface of FIG. 5. When the user selects and presses the button 1011, the system will apply the newly chosen scene transition effect and the system returns to the user interface shown in FIG. 5. When the user selects and presses the button 1012, the editing is cancelled (the application will be closed).

After previewing and editing the slideshow (step S204), the application will compose the slideshow profile into a resulting slideshow file for sharing or playing (step S205). The slideshow editing system converts the slideshow into a video file or a script file in special format. Generally speaking, a video file is easily played by software and hardware. The slideshow editing system according to the present embodiment provides different video formats to meet the user requirement. For example, a slideshow may be set to have a resolution of 720*480 and encoded using MPEG-2 compression for generating a video file compatible with DVD standard. Next, the video file may be burned into a DVD disc. A script file in special format archives the slideshow profile and all the selected image data of the user. The script file usually requires smaller memory space and is able to be re-edited.

It should be noted that although the above-described embodiment of the present invention describes slideshow editing, one skilled in the art would understand that slideshow editing other than the above described are also possible. In other words, the present invention is not limited by the above embodiment, wherein one feature of the present invention is to use a simple input device for controlling and editing images, wherein the input device comprises a plurality of keys for selecting directions (i.e. a navigation function) and executing the operations to control the host to execute an application program for previewing the slideshow immediately without previewing/editing images or/and slideshow on video timeline. Any slideshow editing system and slideshow editing method with equivalent features described above shall be construed to be within the scope of the present invention.

Accordingly, a simple input device and a plurality of user interfaces may be used for previewing image files immediately and interactively edit images into a slideshow. The present invention may be applied in a cell phone, a PDA, a palm game machine or a kiosk (an interactive multimedia information station), which are controlled by a simple input device, with the capability to access multimedia information for executing the slideshow video editing program and completing the disc authoring process.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A system for editing an image file into a slideshow, comprising:
an input device, comprising a group of direction keys and a confirmation key, for sending a control signal;
a host, for receiving said control signal and executing and controlling a program in said host using said input device to preview, edit and adjust said image file without on video timeline, and interactively edit said slideshow without on video timeline; and
a display device, for displaying a frame of said edited and adjusted image file and said slideshow.

2. A method for editing an image file into a slideshow, comprising:
importing one or more image files into a host;
sending a control signal by pressing a direction key and a confirmation key of an input device, wherein said host receives said control signal and executes a program to preview and edit said image file with real time feedback;
generating a slideshow by using said program;
using said input device to control said program to preview and edit said slideshow with real time feedback; and
converting and displaying said edited image file and said edited slideshow.

3. The method according to claim 2, wherein said step of previewing and editing said image file comprises:
rotating said image file.

4. The method according to claim 2, wherein said step of previewing and editing said image file comprises:
adjusting said image file.

5. The method according to claim 4, wherein said step of adjusting said image file comprises:
adjusting an overall exposure.

6. The method according to claim 4, wherein said step of adjusting said image file comprises:
adjusting a local exposure.

7. The method according to claim 4, wherein said step of adjusting said image file comprises:
adjusting a white balance.

8. The method according to claim 4, wherein said step of adjusting said image file comprises:
adjusting a colour saturation.

9. The method according to claim 4, wherein said step of adjusting said image file comprises:
adjusting a focus.

10. The method according to claim 4, wherein said step of adjusting said image file comprises:
adjusting a colour for a special area.

11. The method according to claim 2, wherein said step of previewing and editing said slideshow comprises:
playing and previewing said slideshow immediately; and
selecting a slide from said slideshow for editing.

12. The method according to claim 11, wherein said step for selecting said slide from the slideshow for editing comprises:
setting a display duration of said slide.

13. The method according to claim 11, wherein said step for selecting said slide from the slideshow for editing comprises:
adding a caption into said slide.

14. The method according to claim 11, wherein said step for selecting said slide from the slideshow for editing comprises:
setting a background template of said slide.

15. The method according to claim 11, wherein said step for selecting said slide from the slideshow for editing comprises:
setting transition effects of said slide.

16. The method according to claim 11, wherein said step for selecting said slide from the slideshow for editing comprises:
undo previous action of said slide.

17. The method according to claim 11, wherein said step for selecting said slide from the slideshow for editing comprises:
removing said slide.

18. The method according to claim 11, wherein said step for selecting said slide from the slideshow for editing comprises:
forward/backward jumping display position of said slide.
